(19) United States
(12) Patent Application Publication
(10) Pub. No.: US 2007/0298197 A1
(43) Pub. Date: Dec. 27, 2007

(54) Barrier Agricultural Fumigation Film

(75) Inventors: Marcel Constant Agnes Bruyndonckx, Hoogstraten (BE); Caroline Greet Hans Dockx, Wuustwezel (BE); Wendy Paula Frans Broeckx, Zaventem (BE); Bjorn Peter van Knippenberg, Rotterdam (NL)

Correspondence Address: ADAMS EVANS P.A., Suite 2350 Charlotte Plaza, 201 South College Street, CHARLOTTE, NC, 28244, US

(73) Assignee: RINLANDSE PLASTICS GROEP B.V., Amsterdam (NL)

(21) Appl. No.: 11/426,654

(22) Filed: Jun. 27, 2006

(51) Int. Cl. F16B 4/00

(52) U.S. Cl. 428/34.9

(57) ABSTRACT

A film that provides a fumigant barrier on a raised crop bed includes a barrier material for restricting the flow of a fluid fumigant, and an elastic polymer material for providing elasticity in the film so that the film can be stretched around the crop bed. The barrier material can be a combination of a polyamide, such as copolyamide 6/66, and an amorphous nylon resin. The elastic polymer can be a plastomer, such as an ethylene based octene plastomer or a polyolefin plastomer. The film can also include a polyethylene resin, such as a linear low density polyethylene, to provide strength to the film. The film can be made utilizing a blown film extrusion process.

### TECHNICAL FIELD AND BACKGROUND OF THE INVENTION

The invention relates to a film providing a barrier that restricts the flow of gases. In particular, the invention provides a fumigation film for use in agricultural applications, such as raised crop beds. The film slows the dispersion of fumigants from the raised bed to improve efficacy of the fumigant. The invention can also provide a mulch that accelerates crop growth by retaining heat in the soil during the winter, and cooling the soil in the summer.

Many agricultural crops, such as strawberries, tomatoes and peppers are grown on raised crop beds. These beds are often fumigated with a pesticide before planting to prevent diseases in the soil that adversely affect the plants.

Typically, a fumigant such as methylbromide (MeBr) and chloropicrin (Pic) is injected into the crop beds about two to three weeks before planting via shanks in the soil. Immediately after the fumigant is injected, a fumigation cover film is placed on top of the bed. This is generally done by unrolling the film and pushing the sides in the soil with special rollers. In the next few hours the MeBr/Pic fumigant permeates through the soil and gradually starts to permeate slowly through the film. The early escape of fumigant through the film cover diminishes the efficacy of the fumigant. In order to slow down this permeation of fumigant through the film it is crucial that the film hugs the crop bed tightly. Flapping or rippling of the film caused by wind often results in the fumigant escaping through the film much more quickly.

Embossed high density polyethylene (HDPE) film and metallized low density polyethylene (LDPE) film have been used as fumigation cover films. While both films exhibit flexibility for hugging the crop bed, they provide a less than satisfactory barrier for retarding the escape of fumigant. There are polyamide-polyethylene films that provide a satisfactory fumigant barrier. However, they do not have sufficient elasticity to stretch over and grip the raised crop bed.

Due to the adverse health and environmental risks associated with many pesticides, growers are pressured to reduce the use of fumigants. Therefore, there is a need for a cover film having an excellent fumigant barrier and the necessary elasticity to tightly hug the raised crop bed, in order to maximize the efficacy of the fumigant being used by retaining it within the crop bed for as long as possible.

### SUMMARY OF THE INVENTION

Therefore, it is an object of the present invention to provide a fumigation film for covering raised crop beds that has a barrier for slowing down the escape of a fumigant.

It is another object of the invention to provide a fumigation film that has an elasticity so that it can be stretched over and tightly grip a raised crop bed.

It is yet another object of the invention to provide a fumigation film that also acts as a mulch by retaining heat in the winter and cooling the soil in the summer.

It is yet another object of the invention to provide a fumigation film that helps prevent the growth of weeds by blocking visible light from reaching the crop bed.

These and other objects of the present invention are achieved in the preferred embodiments disclosed below by providing a film that provides a fumigant barrier on a raised crop bed having a barrier material for restricting the flow of a fluid fumigant, and an elastic polymer material for providing elasticity in the film so that the film can be stretched around the crop bed.

According to a preferred embodiment of the invention, the barrier material is a copolyamide, and the elastic polymer is a plastomer.

According to another preferred embodiment of the invention, the barrier material includes one or more of the following: polyamide, amorphous nylon resin, ethylene vinyl alcohol, polyvinyl chloride, polyvinyl alcohol copolymer, polyester, cellophane, and polyvinylidene chloride.

According to yet another preferred embodiment of the invention, the plastomer is a low density ethylene copolymer.

According to yet another preferred embodiment of the invention, the plastomer includes an ethylene based octene plastomer and/or a polyolefin plastomer.

According to yet another preferred embodiment of the invention, the elastic polymer material is an elastomer.

According to yet another preferred embodiment of the invention, the elastomer is a styrenic elastomer.

According to yet another preferred embodiment of the invention, the film includes polyethylene.

According to yet another preferred embodiment of the invention, the film has a thickness of about 15 to 40 microns.

According to yet another preferred embodiment of the invention, the barrier material has a thickness of about 0.5 to 5.0 microns.

According to yet another preferred embodiment of the invention, the barrier material has a thickness of about 1.5% to 15% of a total thickness of the film.

According to yet another preferred embodiment of the invention, the elastic polymer material is about 5% to 35% of the total weight of the film.

According to yet another preferred embodiment of the invention, the film has a blow up ratio of about 1.5 to 4.0.

According to yet another preferred embodiment of the invention, the film can be laid mechanically over the raised crop bed.

According to yet another preferred embodiment of the invention, the film includes one or more of the following: a polyethylene resin, a black colorant, a white colorant, an anti-block additive, an anti-slip additive, a processing additive, an anti-oxidant, a tie-layer additive, and a UV additive.

According to yet another preferred embodiment of the invention, a multi-layered film for providing a fumigant barrier on a raised crop bed includes a polyamide, and a plastomer.

According to yet another preferred embodiment of the invention, the polyamide is about 1.5% to 15.0% of the total mass of the film, and the plastomer is about 5.0% to 35.0% of the total mass of the film.

According to yet another preferred embodiment of the invention, the mass ratio of the plastomer to the polyamide is at least about 1.1.

According to yet another preferred embodiment of the invention, the plastomer is an ethylene based octene plastomer.

According to yet another preferred embodiment of the invention, the film includes a polyethylene resin.

According to yet another preferred embodiment of the invention, the polyethylene resin includes a linear low density polyethylene resin.

According to yet another preferred embodiment of the invention, the film includes a black colorant, a white colorant, an anti-block additive, an anti-slip additive, a processing additive, an anti-oxidant, a tie-layer additive, a UV additive, and a stabilizing additive.

According to yet another preferred embodiment of the invention, the polyamide includes a copolyamide 6/66, the plastomer includes an ethylene based octene plastomer, and the polyethylene resin includes a linear low density polyethylene resin.

According to yet another preferred embodiment of the invention, the tie-layer additive includes an anhydride-modified linear low density polyethylene.

According to yet another preferred embodiment of the invention, the film has an embossed pattern.

### BRIEF DESCRIPTION OF THE DRAWINGS

FIG. 1 is a front elevation of a barrier agricultural fumigation film according to a preferred embodiment of the invention; and

FIG. 2 is a partial exploded view of the film of FIG. 1.

### DETAILED DESCRIPTION OF THE PREFERRED EMBODIMENTS AND BEST MODE

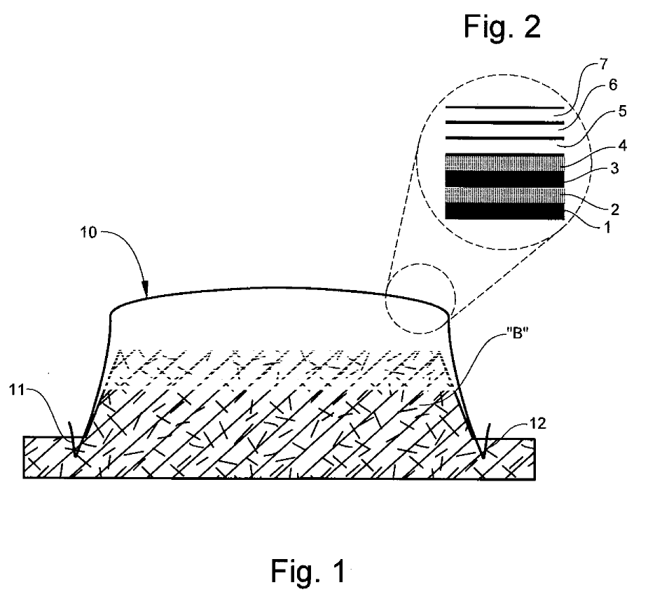

A barrier agricultural fumigation film according to a preferred embodiment of the invention is illustrated in FIG. 1, and shown generally at reference numeral 10. The term “film” as used in this application refers generally and collectively to films, webs, sheets and any other layer of material that can be used as a cover. The film 10 includes a barrier material that restricts the flow of a fluid fumigant, and an elastic polymer that provides sufficient elasticity so that the film can be stretched over and tightly hug a raised crop bed.

In addition, the film 10 is a mulch that retains heat in the winter and cools the soil in the summer. The film 10 also helps prevent the growth of weeds by blocking visible light from reaching the crop bed.

The barrier material of the film 10 is preferably a polyamide, such as a copolyamide 6/66 sold under the trade name ULTRAMID® C33L 01 by BASF. The polaymide preferably comprises about 1.5% to 15.0% of the total mass of the film. In addition, the barrier material preferably includes a nylon resin, such as the amorphous nylon resin sold under the trade name SELAR® PA 3426 by DuPont. Alternatively, the barrier material can be polyamide, amorphous nylon resin, ethylene vinyl alcohol (EVOH), polyvinyl chloride, polyvinyl alcohol copolymer, polyester, cellophane, and/or polyvinylidene chloride copolymer, and any combination thereof.

The elastic polymer can be a plastomer, such as a low density ethylene copolymer, or an elastomer, such as a styrenic elastomer. Preferably, the elastic polymer is an ethylene based octene plastomer sold under the trade name EXACT® 8201 by DexPlastomers, and comprises about 17.1% to 24.2% of the total mass of the film. Another preferred plastomer is a polyolefin plastomer sold under the trade name AFFINITY® VP 8770G1 by Dow. Preferably, the film 10 has a plastomer/polyamide mass ratio of 1.1 or greater.

The barrier material preferably has a thickness of about 0.5 to 5.0 microns, and has a thickness of about 3% to 14% of a total thickness of the film 10. Preferably, the elastic polymer is about 5% to 35% of a total weight of the film 10, and the film 10 has a blow up ratio of about 1.5 to 4.0.

The film 10 includes a polyethylene resin that provides strength to the film 10. Preferably, the film 10 includes a combination of a linear low density resin (LLDPE) such as the resins sold under the trade name ELITE 5400G and/or ELITE 5110 by Dow, and a low density polyethylene resin (LDPE) such as the resin sold under the trade name LD 150 BW sold by ExxonMobil. The film 10 also includes a black colorant, a white colorant, an anti-block additive, an anti-slip additive, a processing additive, an anti-oxidant, a tie-layer additive, a UV additive, and a stabilization additive. In addition, the film 10 can have an embossed pattern to provide greater flexibility.

The black colorant absorbs sunlight in order to heat the soil in the winter. Preferably, the black colorant is a product sold under the trade name POLYBLAK® 1423UV165 by A. Schulman Plastics N.V.

The white colorant cools the soil in the summer by reflecting sun light. A preferred UV-additive is sold under the trade name POLYBATCH® NG 8000 W-HP by A. Schulman Plastics N.V.

The anti-block additive prevent stickyness of film, and improves quality of the winded product. A preferred anti-block additive is sold under the trade name POLYBATCH® IR1515 by A. Schulman Plastics N.V.

The anti-slip additive reduces the slipperyness of the film initially, and then allows the film to become more slippery after twenty-four hours. This is because when winding the film during production it is desirable for the film to not be slippery, but for end-users the film should be somewhat slippery in order to facilitate unrolling of the film. A preferred anti-slip additive is sold under the trade name POLYBATCH® FSU 4951 by A. Schulman Plastics N.V.

The processing additive prevents degradation of the film during the extrusion process when the material is heated. A preferred processing additive is sold under the trade name POLYBATCH® AMF 705 HF by A. Schulman Plastics N.V.

The tie-layer additive is an adhesive resin that facilitates adhesion between varying materials. Preferably, the tie-layer additive is an anhydride-modified linear low-density polyethylene such as the BYNEL® 4100 series of adhesive resins sold by DuPont.

The UV-additive prevents premature degradation due to UV-radiation. A preferred UV-additive is sold under the trade name POLYBATCH® UVS 310 by A. Schulman Plastics N.V.

The stabilization additive prevents UV degradation of the polyamide layer. A preferred stabilization additive is sold under the trade name POLYBATCH® AOPA SE 25 by A. Schulman Plastics N.V.

A preferred anti-oxidant is the phenolic based antioxidant sold under the trade name Ciba® IRGANOX® 1010 by Ciba Specialty Chemicals.

As shown in FIG. 1, the film 10 is positioned over the raised crop bed “B”, and the sides 11, 12 of the film 10 are pushed into the soil of the bed “B”. The film 10 provides a barrier that slows the escape of fumigants permeating from the crop bed “B”, thereby improving the efficacy of the fumigant. The film 10 is preferably comprised of seven layers 1-7, as shown in FIG. 2.

The film 10 can be made utilizing a blown film extrusion process. Each layer 1-7 of the film 10 is made by putting the ingredients of each respective layer 1-7 in a hopper, which releases the mixture of ingredients into an extruder. The extruder heats up the mixture and puts it under pressure, and propels it through a die. The top of the die has seven circles of capillary openings through which the material flows. The number of circles is equal to the number of layers of the film 10. The circles are placed very close to each other, and when the heated mixture is pushed out of the capillary openings, the material slightly expands, thus bonding together with the other layers. When two materials are too alien to properly adhere to one another, such as polyamide and polyethylene resins, a layer containing a tie-layer additive, which can bond with both the polyamide and polyethylene resin layers, can be positioned between the two alien materials to facilitate adhesion of the layers, thereby increasing the strength of the film.

The following Table A shows three formulations 110, 120, 130 of the film 10, and provides the composition of each layer 1-7 of each film 110, 120, 130.

TABLE A

| Component | Film 110 | Film 120 | Film 130 | |
|---|---|---|---|---|
| Layer 1 | 27.2% | 27.2% | 27.2% | or film volume |
| LLDPE Resin | 60.0% | 60.0% | 60.0% | of layer mass |
| LDPE | 19.0% | 19.0% | 19.0% | of layer mass |
| Black colorant | 16.0% | 16.0% | 16.0% | of layer mass |
| Anti-Block Add. | 2.0% | 2.0% | 2.0% | of layer mass |
| Anti-Slip Additive | 1.0% | 1.0% | 1.0% | of layer mass |
| Processing Add. | 1.0% | 1.0% | 1.0% | of layer mass |
| Layer 2 | 10.0% | 10.0% | 10.0% | of film volume |
| Plastomer | 56.0% | 56.0% | 58.0% | of layer mass |
| White colorant | 25.0% | 25.0% | 25.0% | of layer mass |
| Tie-layer additive | 10.0% | 10.0% | 10.0% | of layer mass |
| UV additive | 8.0% | 8.0% | 6.0% | of layer mass |
| Anti-oxidant | 1.0% | 1.0% | 1.0% | of layer mass |
| Layer 3 | 5.7% | 5.7% | 7.1% | of film volume |
| Ultramid ® C33L01 | 77.6% | 77.6% | 78.2 | of layer mass |
| Selar ® PA 3426 | 20.0% | 20.0% | 20.0% | of layer mass |
| Stabilization | 2.4% | 2.4% | 1.8% | of layer mass |
| additive | | | | |
| Layer 4 | 10.0% | 10.0% | 10.0% | of film volume |
| Plastomer | 56.0% | 56.0% | 58.0% | of layer mass |
| White colorant | 25.0% | 25.0% | 25.0% | of layer mass |
| Tie-layer additive | 10.0% | 10.0% | 10.0% | of layer mass |
| UV additive | 8.0% | 8.0% | 8.0% | of layer mass |
| Anti-oxidant | 1.0% | 1.0% | 1.0% | of layer mass |
| Layer 5 | 10.0% | 17.0% | 7.1% | of film volume |
| Plastomer | 66.0% | 66.0% | 0 | of layer mass |
| White colorant | 25.0% | 25.0% | 0 | of layer mass |
| UV additive | 8.0% | 8.0% | 0 | of layer mass |
| Anti-oxidant | 1.0% | 1.0% | 0 | of layer mass |
| Ultramid ® C33L01 | 0 | 0 | 78.2% | of layer mass |
| Selar ® PA 3426 | 0 | 0 | 20.0% | of layer mass |
| Stabilization | 0 | 0 | 1.8% | of layer mass |
| additive | | | | |
| Layer 6 | 10.0% | 17.0% | 10.0% | of film volume |
| Plastomer | 66.0% | 66.0% | 58.0% | of layer mass |
| White colorant | 25.0% | 25.0% | 25.0% | of layer mass |
| UV additive | 8.0% | 8.0% | 6.0% | of layer mass |
| Tie-layer additive | 0 | 0 | 10.0% | of layer mass |
| Layer 7 | 27.1% | 13.1% | 27.9% | of film volume |
| LLDPE resin | 55.0% | 55.0% | 57.0% | of layer mass |
| White colorant | 30.0% | 30.0% | 30.0% | of layer mass |
| UV additive | 8.0% | 8.0% | 6.0% | of layer mass |
| Anti-block additive | 4.0% | 4.0% | 4.0% | of layer mass |
| Anti-slip additive | 1.0% | 1.0% | 1.0% | of layer mass |
| Processing additive | 1.0% | 1.0% | 1.0% | of layer mass |
| Anti-oxidant | 1.0% | 1.0% | 1.0% | of layer mass |

The following Table B provides further information regarding the composition of the films 110, 120, 130.

TABLE B

| | cross | copolyamide | | | plastomer/ |
|---|---|---|---|---|---|
| | section | layer | mass % | mass % | copolyamide |
| Film | (microns) | (microns) | copolyamide | plastomer | ratio |
| 110 | 30.7 | 2 | 5.99% | 24.2% | 4.04 |
| 120 | 34.0 | 2 | 6.29% | 34.7% | 5.52 |
| 130 | 34.0 | 5 | 14.96% | 17.1% | 1.14 |

The results of physical testing on the films 110, 120, 130 are shown in the following Table C.

TABLE C

| Physical | | | |
|---|---|---|---|
| Characteristic | Film 110 | Film 120 | Film 130 |
| Dart Drop (grams) | 736 | 766 | 975 |
| Tensile Strength- | 38.9 | 40.9 | 46.9 |
| machine direction | | | |
| (million pascal) | | | |
| Tensile Strength- | 40.2 | 43.8 | 40.7 |
| transversal direction | | | |
| (million pascal) | | | |
| Maximum Elongation- | 525.6% | 565.9% | 435% |
| machine direction (%) | | | |
| Maximum Elongation- | 629.2% | 648.3% | 445% |
| transversal direction | | | |
| (%) | | | |
| Tear resistance- | 9.9 | 12.1 | 13.4 |
| machine direction | | | |
| (grams/microns) | | | |
| Tear resistance- | 13.7 | 13.8 | 20.3 |
| transversal direction | | | |
| (grams/microns) | | | |
| E-modulus- | 147.7 | 89.3 | 180 |
| machine direction | | | |
| (million pascal) | | | |
| E-modulus- | 151.5 | 93.1 | 150 |
| transversal direction | | | |
| (million pascal) | | | |
| Oxygen Transfer | 392.2 | 463.2 | 183.9 |
| Ratio - Cell A | 35.8 μm | 34.6 μm | 34.9 μm |
| (cc/m²/day) | | | |
| Oxygen Transfer | 490.7 | 563.6 | 174.2 |
| Ratio - Cell B | 34.4 μm | 33.7 μm | 34.6 μm |
| (cc/m²/day) | | | |

An important physical characteristic of the films 110, 120, 130 is the ability to stretch easily in order to cover a raised crop bed. This characteristic is measured by the E-modulus and maximum elongation values provided in Table C above. The E-modulus values are inversely related to the level of elasticity of the films 110, 120, 130.

The maximum elongation is the point of elongation at which a film starts to tear. For example, film 110 began to tear when stretched to 629% of its original length. E-modulus, elongation and tensile strength were measured using ASTM standard test D882.

The dart drop values were calculated using ASTM test D1709. The oxygen transfer ratios were measured using ASTM test D3985 at 23 degrees Celsius and relative humidity of 75%.

A barrier agricultural fumigation film, and methods of making and using same are described above. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

What is claimed is:

1. A film for providing a fumigant barrier on a raised crop bed, comprising:
(a) a barrier material for restricting the flow of a fluid fumigant; and
(b) an elastic polymer material for providing elasticity in the film whereby the film can be stretched around the crop bed.

2. A film according to claim 1, wherein the barrier material comprises at least one of the group consisting of polyamide, nylon resin, ethylene vinyl alcohol, polyvinyl chloride, polyvinyl alcohol copolymer, polyester, cellophane, and polyvinylidene chloride.

3. A film according to claim 1, wherein the elastic polymer material comprises a plastomer.

4. A film according to claim 3, wherein the plastomer comprises a low density ethylene copolymer.

5. A film according to claim 3, wherein the plastomer comprises at least one of the group consisting of an ethylene based octene plastomer and a polyolefin plastomer.

6. A film according to claim 1, wherein the elastic polymer material comprises an elastomer.

7. A film according to claim 6, wherein the elastomer comprises a styrenic elastomer.

8. A film according to claim 1, further comprising polyethylene.

9. A film according to claim 1, wherein the film has a thickness of about 15 to 40 microns.

10. A film according to claim 1, wherein the barrier material has a thickness of about 0.5 to 5.0 microns.

11. A film according to claim 1, wherein the barrier material has a thickness of about 1.5% to 15% of a total thickness of the film.

12. A film according to claim 1, wherein the elastic polymer material comprises about 5% to 35% of a total weight of the film.

13. A film according to claim 1, wherein the film has a blow up ratio of about 1.5 to 4.0.

14. A film according to claim 1, wherein the film can be laid mechanically over the raised crop bed.

15. A film according to claim 1, further comprising at least one of the group consisting of: a polyethylene resin, a black colorant, a white colorant, an anti-block additive, an anti-slip additive, a processing additive, an anti-oxidant, a tie-layer additive, and a UV additive.

16. A multi-layered film for providing a fumigant barrier on a raised crop bed, comprising:
(a) a barrier material comprising at least one from the group consisting of polyamide and amorphous nylon resin; and
(b) a plastomer.

17. A film according to claim 16, wherein the barrier material comprises about 1.5% to 15.0% of a total mass of the film, and the plastomer comprises about 5.0% to 35.0% of the total mass of the film.

18. A film according to claim 16, wherein a mass ratio of the plastomer to the barrier material is at least about 1.1.

19. A film according to claim 16, wherein the plastomer comprises an ethylene based octene plastomer.

20. A film according to claim 16, further comprising a polyethylene resin.

21. A film according to claim 20, wherein the polyethylene resin comprises a linear low density polyethylene resin.

22. A film according to claim 20, further comprising:
(a) a black colorant;
(b) a white colorant;
(c) an anti-block additive;
(d) an anti-slip additive;
(e) a processing additive;
(f) an anti-oxidant;
(g) a tie-layer additive;
(h) a UV additive; and
(i) a stabilizing additive.

23. A film according to claim 22, wherein:
(a) the barrier material comprises a copolyamide 6/66 and an amorphous nylon resin;
(b) the plastomer comprises an ethylene based octene plastomer; and
(c) the polyethylene resin comprises a linear low density polyethylene resin.

24. A film according to claim 23, wherein the tie-layer additive comprises an anhydride-modified linear low density polyethylene.

25. A film according to claim 16, wherein the film includes an embossed pattern.
